(19) United States
(12) Patent Application Publication
(10) Pub. No.: US 2005/0268758 A1
(43) Pub. Date: Dec. 8, 2005

(54) Adjustable torque wrench having fixed torsion value

(76) Inventor: Lee Chang Chuan, Nan Tou Hsien (TW)

Correspondence Address: CHARLES E. BAXLEY, ESQ., 90 JOHN STREET, THIRD FLOOR, NEW YORK, NY, 10038, US

(21) Appl. No.: 10/858,652

(22) Filed: Jun. 2, 2004

(51) Int. Cl. B25B 23/14

(52) U.S. Cl. 81/467

(57) ABSTRACT

An adjustable torque wrench having fixed torsion value is provided with a positioning structure, through which the torsion value of the wrench can be well maintained and fixed after adjustment so as to improve work efficiency, in addition, which is further provided with a plurality of protrusions and orifices, the engagement structure between the protrusions and the orifices enables the adjustment on torsion value to be more exactly and precisely performed.

### BACKGROUND OF THE INVENTION

1. Field of the Invention

The present invention relates to an adjustable torque wrench, and more particularly to a wrench having an ability of fixing and maintaining the torsion value after adjustment.

2. Description of the Prior Arts

With the improvement on the rate of utilization of the hand tools, the demand on the functions of the hand tool is increased accordingly. Adjustable torque wrench is one of the tools most commonly used, and which is mainly applied to the parts that require accurate torsion values (such as engine housing, cylinder, clutch and etc.). However, how to develop an adjustable torque wrench which torsion value can be well fixed and maintained after adjustment has become the problem that the producers want to overcome mostly and also is the motivation of the present invention.

As shown in FIG. 1, a conventional adjustable torque wrench generally comprises a base body 10, a central rod 11 and an adjusting handle 12. Wherein at a first end of the base body 10 is provided with a driving head 13 and at a second end of the base body 10 an adjusting handle 12 is adjustably disposed. The central rod 11 is received in the base body 10 and fixed to the adjusting handle 12 by virtue of a fixture 14, which revolves along with the adjustment of the adjusting handle 12, such that the torsion value of which can be set by virtue of the adjustment of the adjusting handle 12. However, there are still some disadvantages need to be improved in operation.

The adjusting handle 12 is adjustably disposed at the second end of the base body 10, while after the user set the torsion value according to the indicated graduation of the base body 10, in operation, the torsion value is probably changed while the user holding the adjusting handle 12 and needs to be adjusted back to the original set torsion value again, such decreases the work efficiency.

The present invention has arisen to mitigate and/or obviate the afore-described disadvantages of the conventional adjustable torque wrench.

### SUMMARY OF THE INVENTION

The primary object of the present invention is to provide an adjustable torque wrench having fixed torsion value that is provided with a positioning structure, through which the torsion value can be fixed and maintained after adjustment whereby to increase work efficiency.

Another object of the present invention is to provide an adjustable torque wrench having fixed torsion value that is provided with a plurality of protrusions and orifices, the engagement structure between the protrusions and the orifices enables the adjustment on torsion value to be more exactly and precisely performed.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a plan view, partly in section, of a conventional adjustable torque wrench;

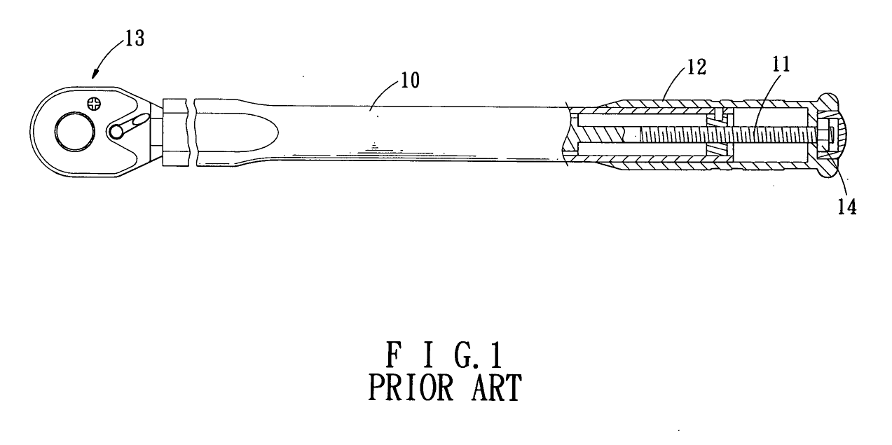

FIG. 2 is an exploded view of an adjustable torque wrench in accordance with the present invention;

FIG. 3 is a side view of the adjustable torque wrench in accordance with the present invention;

FIG. 4 is a cross sectional view of the adjustable torque wrench in accordance with the present invention;

FIG. 5 is another cross sectional view of the adjustable torque wrench in accordance with the present invention;

FIG. 6 is a partial amplified view of the adjustable torque wrench in accordance with the present invention.

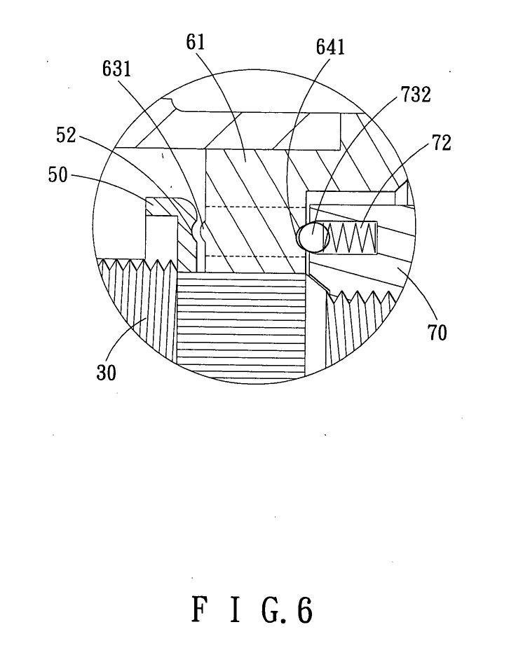

### DETAILED DESCRIPTION OF THE PREFERRED EMBODIMENT

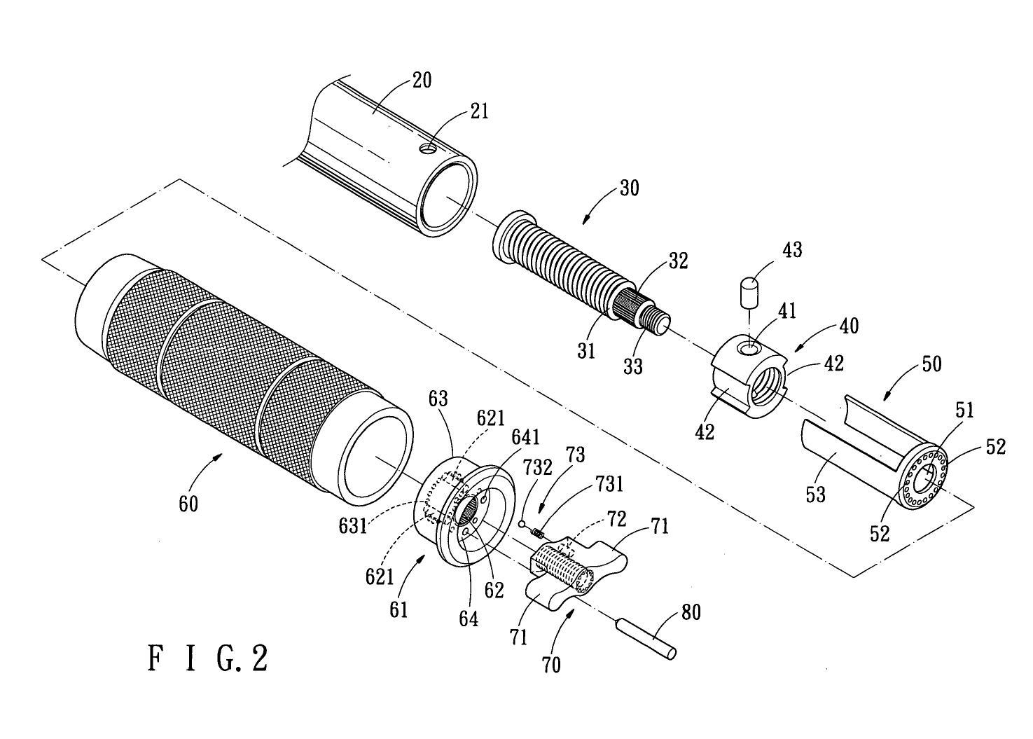

Referring to FIGS. 2-4, an adjustable torque wrench having fixed torsion value in accordance with the present invention generally comprises a wrench body 20, a central rod 30, a positioning block 40, an engaging member 50, an adjusting handle 60, a fixture 70 and a limiter 80.

The wrench body 20 is a tubular member and provided with a driving head (not shown) at an end and an aperture 21 at another end.

The central rod 30 is provided with a peripheral shoulder 31, connecting to the shoulder 31 is a toothed portion 32 formed, while next to the toothed portion 32 is defined with a threaded portion 33. The central rod 30 is received in the wrench body 20 and able to change the torsion value of the wrench after adjustment.

The positioning block 40 is provided at the periphery with a hole 41 and two grooves 42 respectively; the positioning block 40 is corresponding to the aperture 21 of the wrench body 20 and positioned in the wrench body 20 by virtue of a pin 43.

The engaging member 50 has a hole 51 defined thererof, around the contiguous periphery of the hole 51 a plurality of orifices 52 are defined, the engaging member 50 is further provided at both sides with an inserting plate 53 respectively. The engaging member 50 serves to mount onto the central rod 30 with the two inserting plates 53 inserted in the two grooves 42 of the positioning block 40 respectively while the hole 51 abutting against the shoulder 31 of the central rod 30.

The adjusting handle 60 has a transmission block 61 disposed at an end; the transmission block 61 is provided with a toothed hole 62, a first end surface 63 and a second surface 64 with corresponding to each other. Contiguous to the toothed hole 62 four inserting holes 621 are formed thereof. The first end surface 63 is annularly provided with a plurality of protrusions 631 while the second end surface 64 is alike annularly provided with a plurality of apertures 641. The adjusting handle 60 is adjustably disposed at the end of the wrench body 20 in a manner that the protrusions 631 engaged with the orifices 52 respectively, the toothed hole 62 engaged with toothed portion 32 of the central rod 30 and the threaded portion 33 of the central rod 30 protrudes out of the toothed hole 62. By adjusting the handle 60 the central rod 30 is revolved accordingly.

The fixture 70 is provided with a pair of ear portions 71, at one of the ear portions 71 a recess 72 is formed for receipt of a resilient device 73, the resilient device 73 consists of a spring 731 and a steel ball 732. The steel ball 732 is able to timely protrude out of the mouth of the recess 72. The fixture 70 serves to screw on the threaded portion 33 of the central rod 30 and the steel ball 732 of resilient device 73 engages with corresponding apertures 641 of the transmission block 61.

The limiter 80 is a column member and removably inserted in one of the inserting holes 621 of the transmission block 61, furthermore, the limiter 80 corresponding to the two ear portions 71 of the fixture 70 and serves to prevent the loose of the fixture 70 after the same is screwed on the central rod 30.

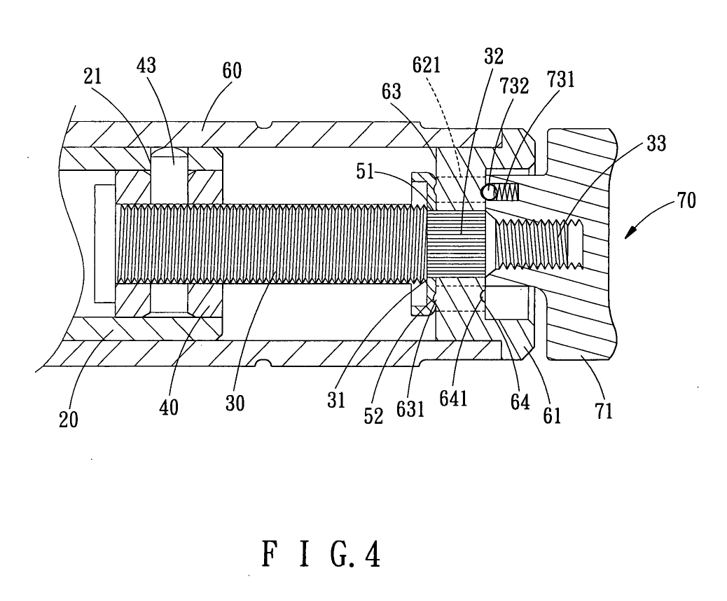

Referring now to FIG. 4, in which, in case that the user adjusts the adjusting handle 60 to a predetermined torsion value, then revolves the fixture 70, the fixture 70 presses against the second end surface 64 of the transmission block 61 and the first end surface 63 of the transmission block 61 presses against the engaging member 50 accordingly, while the engaging member 50 then will press the shoulder 31 of the central rod 30. In addition, due to the two inserting plates 53 of the engaging member 50 insert in the two grooves 42 of the positioning block 40, and the positioning block 40 and wrench body 20 are positioned with relative to each other (that is to say the positioning block 40 is unable to revolve with respect to the wrench body 20). Accordingly, the position of the adjusting handle 60 can be locked completely after it is adjusted, such that the torsion value of wrench will not be changed during operation and the work efficiency is accordingly increased.

In addition, in case that wants to change the torsion value of adjustable torque wrench, the user can unscrew the fixture 70 initially, and then adjust the adjusting handle 60 to a desired force indicated on the graduator of the wrench base 20, and finished by screwing up the fixture 70.

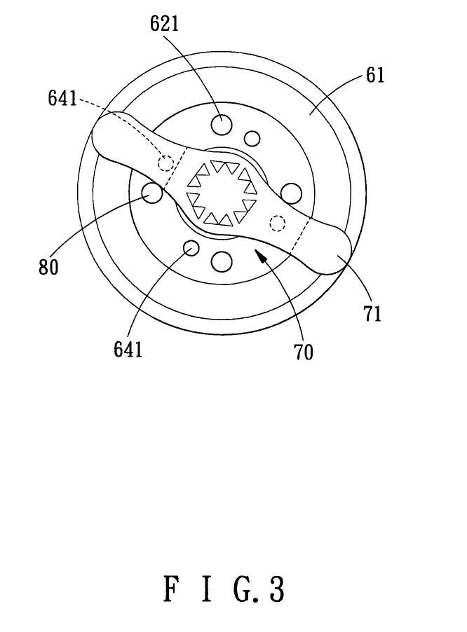

Referring again to FIG. 3, in which, in case of a loose state of the fixture 70, due to the limiter 80 is inserted in the transmission block 61 and located in the revolving scope of the fixture 70. In other words, in case of revolution of the fixture 70, which ear portions 71 stopped by the limiter 80 and unable to revolve further. In this case, the fixture 70 only can be unscrewed in a certain range and unable to be disengaged from the threaded portion 33 of the central rod 30. Such that prevent the toothed portion 32 of the central rod 30 disengaging from the toothed hole 62 of the transmission block 61 of the adjusting handle 60, and further prevent the failure of the wrench in adjusting the predefined torsion value.

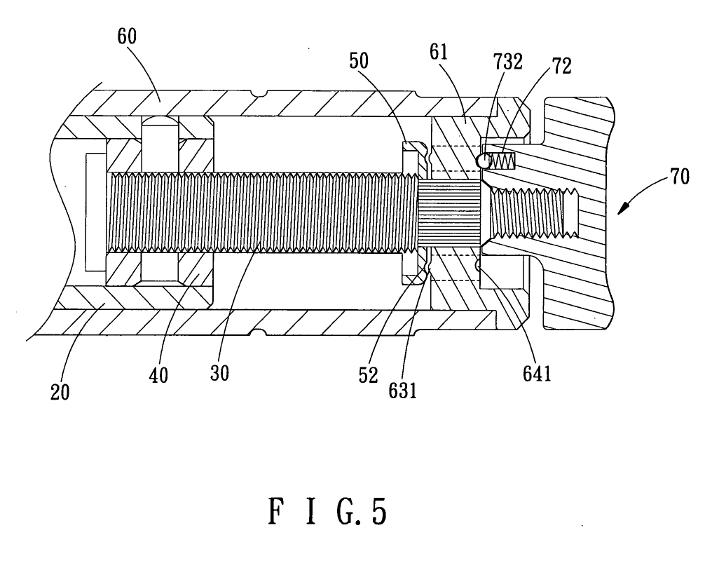

On the other hand, with referring to FIGS. 5,6, in which, in case of revolution of the fixture 70, the steel ball 732 in the fixture 70, under the pressure of the internal surface of the aperture 641 of the transmission block 61, moves within the recess 72, which steel ball 732 will not engage in the aperture 641 again until next aperture 641, such that the fixture 70 is positioned. After the fixture 70 is unscrewed, the adjusting handle 60 is allowed to be pulled toward the fixture 70 such that the transmission block 61 doesn't tightly abut against the engaging member 50 any more and then the adjusting handle 60 is able to adjust the torsion value. In operation, due to the transmission block 61 is annularly provided with a plurality of protrusions 631 and the engaging member 50 is annularly provided with a plurality of orifices 52, the adjusting handle 60 is allowed to adjust the torsion value based on the distance of the adjacent paired orifices 52 (protrusions 631) such that ensures the torsion adjustment to be more exactly and precisely performed.

While we have shown and described various embodiments in accordance with the present invention, it should be clear to those skilled in the art that further embodiments may be made without departing from the scope of the present invention.

1. An adjustable torque wrench having fixed torsion value comprising:
a wrench body;
a central rod received in the wrench body and having a periphery shoulder, a toothed portion and a threaded portion;
a positioning block having a pair of grooves defined at the periphery thererof, the positioning block serving to screw on the central rod and positioned with respect to the wrench body;
an engaging member having a plurality of orifices annularly defined at an end thererof, at the periphery of the engaging member a pair of inserting plates being defined for serving to insert in the two grooves of the positioning block with the engaging member abutting against the shoulder of the central rod;
an adjusting handle being provided at an end with a transmission block, the transmission block having a toothed hole and a pair of corresponding first end surface and second end surface, the first end surface having a plurality of protrusions while the second end surface having a plurality of apertures, the adjusting handle adjustably disposed at the end of the wrench body in the manner that the protrusions engaged with the orifices respectively, the toothed hole engaged with toothed portion of the central rod and the threaded portion of the central rod protruding out of the toothed hole;
a fixture being provided with a pair of ear portions, in one of the ear portions a resilient device being disposed, the fixture serving to screw on the threaded portion of the central rod, and the resilient device corresponding to the apertures of the transmission block;
a limiter removably disposed contiguous to the toothed hole of the adjusting handle and corresponding to the ear portions of the fixture.

2. The adjustable torque wrench having fixed torsion value as claimed in claim 1, wherein the wrench body is provided at an end with an aperture with the positioning block having a hole corresponding to the aperture of the wrench body, the positioning block is positioned in the wrench body by virtue of a pin.

3. The adjustable torque wrench having fixed torsion value as claimed in claim 1, wherein the transmission block of the adjusting handle is equidistantly provided contiguous to the toothed hole thereof with four inserting holes for insertion of the limiter whereby to change the disposing position.

4. The adjustable torque wrench having fixed torsion value as claimed in claim 1, wherein the fixture has a recess defined at one of the ear portions for accommodation of the resilient device.

5. The adjustable torque wrench having fixed torsion value as claimed in claim 1, wherein the resilient device includes a spring and a steel ball.

6. The adjustable torque wrench having fixed torsion value as claimed in claim 4, wherein the resilient device includes a spring and a steel ball.
